(19) United States
(12) Patent Application Publication
(10) Pub. No.: US 2005/0074276 A1
(43) Pub. Date: Apr. 7, 2005

(54) Method for aligning and mounting two components on a support member in a positionally accurate manner

(76) Inventors: Thomas Luetze, Eutingen im Gaeu (DE); Roman Pelz, Sindelfingen (DE)

Correspondence Address: KENYON & KENYON, ONE BROADWAY, NEW YORK, NY, 10004, US

(21) Appl. No.: 10/436,705

(22) Filed: May 12, 2003

(30) Foreign Application Priority Data
May 11, 2002 (DE) 102 20 985.5

(51) Int. Cl. F16B 5/02

(52) U.S. Cl. 403/14; 403/11; 403/388; 403/386

(57) ABSTRACT

In a method for aligning and mounting two components, a guide part and a follower part, on a support member in a positionally accurate manner, and a joining region of these components, in order to align two components relatively to each other and to other adjacent components, on a support member, in a positionally accurate manner and with a minimum amount of expenditure, the following method steps may be provided: the guide part is placed in position on the support member; a distance element is inserted into the openings in the guide part and the follower part so that it fixes the position of the follower part relative to the guide part; and the follower part and the guide part are jointly fixed in position in the attachment region, with respect to the support member.

### CROSS-REFERENCE TO RELATED APPLICATIONS

The present application claims priority to Application No. 102 20 985.5, filed in the Federal Republic of Germany on May 11, 2002, which is expressly incorporated herein in its entirety by reference thereto.

### FIELD OF THE INVENTION

The present invention relates to a method for aligning and mounting two components on a support member, as well as a joining region between two components and a support member.

### BACKGROUND INFORMATION

During the assembly of car-body components in automobile manufacturing, the problem of having to mount several components relatively to each other so as to have a particular, uniform gap between the components, occurs often. In this context, it is, above all, difficult to simultaneously align the components relatively to each other and with respect to the body prior to finally mounting them.

German Published Patent Application No. 199 12 181 describes a method for mounting components of a motor-vehicle front end, that is the engine 100, hood latch, manufacturer's emblem, and radiator grille, so as to have exact tolerances. In this case, a reference marking is provided on a mounting support, the reference marking being used during the alignment of all the other parts. However, this method is relatively expensive. First of all, it requires that the mounting support be exactly aligned with the reference marking on the body beforehand. Secondly, a special manipulation tool has to be used to align the other components with respect to the reference marking. The method is too complicated for mounting just two components to a support member in a positionally accurate manner.

It is an object of the present invention to provide a method and a joining region produced by the method, by which two components may be simultaneously aligned relatively to each other and other adjacent components and mounted to a support member, where the amount of expenditure may be minimal.

### SUMMARY

The above and other beneficial objects of the present invention may be achieved by providing a method as described herein and/or by providing a region as described herein.

In accordance with an example embodiment of a method of the present invention, two components, a guide part and a follower part are aligned with and mounted to a support member in a positionally accurate manner. A corresponding joining region is provided in another example embodiment of the present invention. In this context, the support member includes an alignment element for placing the guide part in position on the support member. The guide part has a guide opening, whose position in an assembled state of the support member and the guide part overlaps the position of an attachment region on the support member, within the tolerances to be adjusted or compensated for. The follower part has a follower opening, which coincides with the guide opening, when the follower part is brought into the desired alignment with the guide part. The guide part is first placed in position on the support member, at the alignment element. A distance element matched or conformed to the outer contour of the follower opening is then inserted into the guide opening and the follower opening in such a manner, that it fixes the position of the follower part relative to the guide part. In the attachment region, the follower part and guide part are then jointly fixed in position with respect to the support member.

An aspect of the method according to an example embodiment of the present invention may provide that two components may simultaneously be aligned, on one hand, with each other and, on the other hand, with other adjacent components. In this context, the guide part predetermines the position and is placed in position at the alignment element of the support member, with respect to further components aligned with respect to the support member, while the follower part is bound to the position of the guide part by the distance element, and only has to be aligned together with the guide part.

In the attachment region, the guide part and follower part may be fixed in position with respect to the support member, in a nut rigidly connected to the support member, using a screw guided through a hollow space of the distance element. This may provide a simple and cost-effective fastening method.

Initially, the distance element may be inserted into the follower opening in such a manner, that a centering region of the distance element juts out beyond the surface facing the guide part. The follower part is then placed, along with the distance element, on the guide part in such a manner, that the guide opening is penetrated by the centering region. Thus, a pressure sleeve, which may be conventional in principle and may be inexpensive and suitable for large-scale production, may be used as a distance element. Furthermore, the follower part and guide part may be aligned relatively to each other very easily, when the follower part is put on or mounted together with the pressure sleeve.

The method may be used for aligning and mounting a lamp and a bumper to a car-body component of a motor vehicle in a positionally accurate manner. The method may be applicable to the mounting of these components, since special requirements regarding their positionally accurate installation may be made, which may render manual, positionally accurate alignment and mounting of the individual parts complicated.

Furthermore, a joining region of two components to a support member may be provided according to an example embodiment of the present invention, the support member being provided with an alignment element for aligning the guide part with the support member in a positionally accurate manner. The guide part has a guide opening, whose position in an assembled state of the support member and the guide part overlaps the position of an attachment region on the support member, within the tolerances to be compensated for, while the follower part has a follower opening which coincides with the guide opening when the follower part is aligned with the guide part in the desired manner. The follower opening and guide opening are penetrated by a distance element, which is conformed to the outer contour of the follower opening and fixes the follower part and guide part in position in the attachment region, with respect to the support member, using a fastening device or means.

The fastening device may include a bolt guided through a hollow space of the distance element and a nut rigidly connected to the support member. This may provide that the components forming the joining region may be detached again from each other, if necessary. A nut rigidly connected to the support member may provide that fewer free parts are present.

The guide opening and the follower opening may be approximately circular. In this manner, the distance element may be particularly easy to manufacture from a standpoint of production engineering.

The guide opening may include a bevel on the side facing the follower part. This bevel has a centering effect when the distance element is inserted. In the case of the assembly of the attachment region, it is possible, in this manner, to put the follower part, along with the distance element, on the guide part with a high degree of process reliability.

In an example embodiment of the present invention, the guide opening is lined with a supplemental sleeve, whose inner diameter corresponds to the diameter of the follower opening. This arrangement may provide that the guide part has an additional degree of freedom, in that it may be moved relatively to the follower part in the direction of the center line of the supplemental sleeve.

In an example embodiment of the present invention, the distance element may be pre-fixed in position in the follower part by a nut and/or spring and has a bevel on the side facing the support member. In this manner, the distance element may already be reliably fixed in position in the follower part prior to mounting and may also be centered more effectively in the guide part during mounting.

Further features and aspects of the present invention are described below.

The present invention is explained in detail in the drawings, using several exemplary embodiments.

### BRIEF DESCRIPTION OF THE DRAWINGS

FIG. 1 illustrates individual components at the beginning of the mounting method.

FIG. 2 illustrates the pre-mounted condition.

FIG. 3 illustrates the joining region after implementing the method.

FIG. 4 illustrates an alternative example embodiment of the joining region.

### DETAILED DESCRIPTION

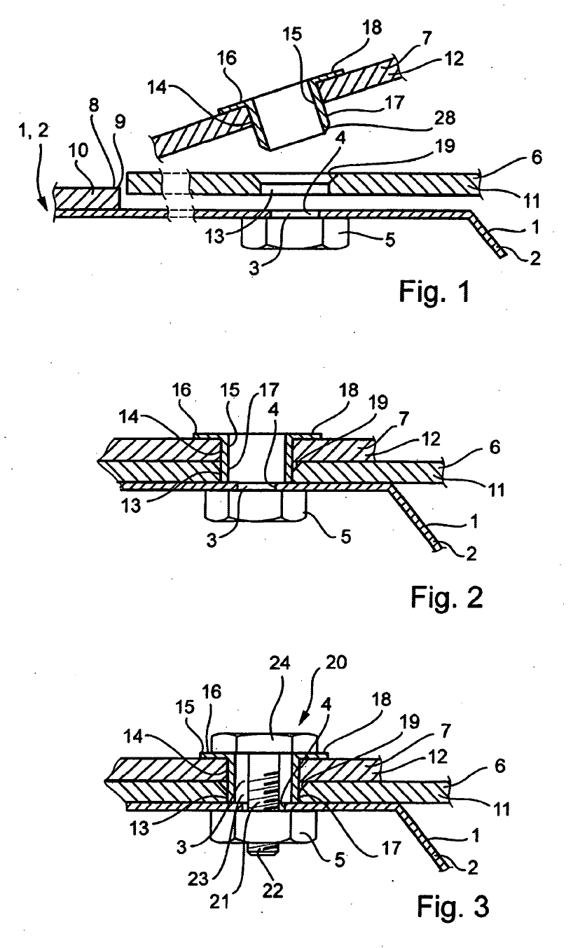

In FIG. 1, the components to be connected to each other in a positionally accurate manner are represented at the start of implementation of the method according to an example embodiment of the present invention. Illustrated is a support member 1, which may be, e.g., a car-body component 2 of a motor vehicle, to which components of a motor-vehicle front end are to be mounted. Located on support member 1 is an attachment region 3, which is formed, in this exemplary embodiment, by an opening 4 in support member 1 and a nut 5 rigidly connected to support member 1. In this attachment region 3, two other components, a guide part 6 and a follower part 7, shall be attached to support member 1. Support member 1 also has an alignment element 8, which may ensure that the components mounted to support member 1 are aligned. As illustrated in the drawing, this alignment element 8 may be formed, for example, by an edge 9 of an adjacent component 10, from which guide part 6 may assume a specific distance.

In addition, FIG. 1 illustrates guide part 6, which may be a lamp 11, and follower part 7, which may be a bumper 12 to be situated next to lamp 11 to form an exact gap. In these cases, component regions 1, 6, 7 represented in the drawing are regions, which are provided for the attachment of these components, e.g., attachment plates rigidly connected to the components or attachment flanges extruded onto the components. Guide part 6 includes a guide opening 13 which, in the assembled state of guide part 6 and support member 1 illustrated in FIG. 2, overlaps attachment region 3 or opening 4. Guide opening 13 has a larger diameter than opening 4, in order to be able to catch or trap the component tolerances occurring during mounting, due to a non-concentric position of guide opening 13 with respect to opening 4.

Also illustrated in FIG. 1 is follower part 7, which includes a follower opening 14 that, in this exemplary embodiment, is already penetrated by a distance element 15 prior to the start of the mounting method. Distance element 15, which has a hollow cylindrical geometry in this example, rests, with the aid of a supporting edge 16, on the surface of follower part 7 facing away from guide part 6 and has, on the side facing guide part 6, a centering region 17 protruding from follower part 7. In this context, the outer diameter of centering region 17 corresponds to the diameter of guide opening 13. In this exemplary embodiment, distance element 15 is a metal pressure sleeve 18, which may be conventional and has a detent that may ensure that it is locked in follower part 7. In an example embodiment, the side of distance element 15 facing support member 1 has a bevel 28, which may make it easier to subsequently center distance element 15 in guide part 6.

The method for mounting guide part 6 and follower part 7 to support member 1 in a positionally accurate manner proceeds in or according to the following steps:

The first step of the method includes, initially, the alignment of guide part 6 relative to support member 1. Alignment element 8 is used for this purpose. In this exemplary embodiment, alignment element 8 is formed by an edge 9, so that guide part 6 is aligned with this edge 9 on support member 1 in a dimensionally accurate manner. With reference to its interfaces, guide part 6 is therefore aligned with adjacent components 10, such as the fender of the motor vehicle, and is temporarily fixed in position with respect to support member 1. In this context, the fact that guide opening 13 is wider than opening 4 allows component tolerances and positional tolerances to be trapped during this mounting.

In a second method step illustrated in FIG. 2, follower part 7 is placed, along with distance element 15, on guide part 6 in such a manner, that guide opening 13 is penetrated by centering region 17 of distance element 15. A bevel 19, with which guide opening 13 is provided on the surface facing away from support member 1, may be used to center centering region 17 more effectively. Guide opening 13, follower opening 14, and distance element 15 are adjusted or matched to each other in such a manner, that the position of follower part 7 is clearly fixed with respect to guide part 6. Therefore, the alignment of guide part 6 automatically predetermines the alignment of follower part 7.

Joining region 20 of the three components after execution of the last method step is illustrated in FIG. 3. In this last step, a fastening device in the form of a bolt 22 is guided through hollow space 23 of distance element 15 and screwed into nut 5 in attachment region 3, so that guide part 6 and follower part 7 are rigidly connected to support member 1. Head 24 of bolt 22 rests on supporting edge 16 of distance element 15. The method is now finished, and guide part 6 and follower part 7 are joined to support member 1 in the desired position.

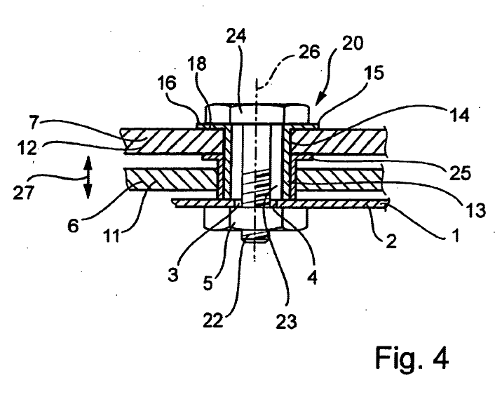

An alternative example embodiment of joining region 20 is illustrated in FIG. 4. In this case, guide opening 13 is additionally lined with a supplemental sleeve 25. In this context, this supplemental sleeve 25 is arranged so that its outer diameter is conformed to the outer contour of guide opening 13 and its inner diameter corresponds to the outer contour of distance element 15. Supplemental sleeve 25, which may be made of plastic, may be inserted into guide opening 13 prior to the first method step. In this manner, an additional degree of freedom may be obtained for guide part 6. Thus, as indicated in the drawing by an arrow 27, a lamp 11, for example, may additionally be moved in the direction of center line 26 of supplemental sleeve 25, even after the mounting. This may be realized, using an external thread on supplemental sleeve 25, which engages with an internal thread of guide part 6, and a hexagon head on supplemental sleeve 25.

The method and joining region 20 are not limited to the above-mentioned exemplary embodiments.

Rather, besides the screw connection illustrated in FIGS. 1 through 4, another manner of and arrangement for fastening in attachment region 3 is possible, for example, clips, a bayonet catch, etc.

Furthermore, the geometry of distance element 15 does not have to correspond to that illustrated. An arrangement that is not in the shape of a hollow cylinder is also possible, e.g., a solid cylindrical sleeve having a thread provided on its face for screwing it in. However, no nut 5 rigidly connected to support member 1 may then be provided, since the tolerance adjustment then takes place via this nut 5.

Alignment element 8 may also be in another form. Thus, guide part 6 may be aligned on support member 1 by a projection on support member 1 and a corresponding depression in guide part 6. In addition, alignment element 8 may also be formed by other reference points, which are fixed to the body, and with respect to which support member 1 is aligned.

Furthermore, details of the method may vary from the steps represented above. For example, it may be provided to not insert distance element 15 into guide opening 13 and follower opening 14 until a later time.

1. A method for aligning and mounting two tolerance-encumbered components on a support member, the support member including an alignment element configured to align a first one of the components with the support member, the first one of the components including a guide opening positioned to overlap a position of an attachment region on the support member, within tolerances to be compensated for, in an assembled state of the support member and the first one of the components, a second one of the components including a follower opening arranged to coincide with the guide opening when the second one of the components is brought into desired alignment with the first one of the components, comprising:
aligning the first one of the components with the alignment element on the support member;
inserting a distance element conformed to an outer contour of the follower opening and the guide opening into the guide opening and the follower opening to fix a position of the second one of the components relative to the first one of the components; and
jointly fixing the second one of the components and the first one of the components in position in the attachment region with respect to the supporting member.

2. The method according to claim 1, wherein the two components include a guide part and a follower part.

3. The method according to claim 1, wherein the first one of the components includes a guide part.

4. The method according to claim 1, wherein the second one of the components includes a follower part.

5. The method according to claim 1, wherein the first one of the components and the second one of the components are fixed in position in the fixing step in a nut rigidly connected to the supporting member by a bolt arranged through a hollow space of the distance element.

6. The method according to claim 1, wherein the inserting step includes:
initially inserting the distance element into the follower opening so that a centering region of the distance element extends beyond a surface facing the first one of the components; and
then placing the second one of the components along with the distance element on the first one of the components so that the guide opening is penetrated by the centering region.

7. The method according to claim 1, wherein:
a first one of the first one of the components and the second one of the components includes a lamp;
a second one of the first one of the components and the second one of the components includes a bumper;
the support member includes a car-body component of a motor vehicle; and
the method is adapted to align and mount the lamp and the bumper to the car-body component of the motor vehicle positionally accurately.

8. A region of joining of a guide part and a follower part to a support member, comprising;
an alignment element of the support member configured to align the guide part with the support member positionally accurately;
a guide opening of the guide part positioned, in an assembled state of the support member and the guide part, to overlap a position of an attachment region on the support member within tolerances to be compensated for;
a follower opening of the follower part arranged to coincide with the guide opening in accordance with the follower part being brought into a desired alignment with the guide part;
a distance element conformed to an outer contour of the follower opening adapted to penetrate the follower opening and the guide opening; and
a fastener device configured to fix the follower part and the guide part in position in the attachment region with respect to the support member.

9. The joining region according to claim 8, wherein the fastener device includes a bolt arranged through a hollow space of the distance element and a nut rigidly connected to the support member.

10. The joining region according to claim 8, wherein the guide opening and the follower opening are approximately circular.

11. The joining region according to claim 8, further comprising a bevel arranged on a side of the guide opening that faces the follower part.

12. The joining region according to claim 8, further comprising a supplemental sleeve lining the guide opening, the sleeve including an inner diameter that corresponds to a diameter of the follower opening.

13. The joining region according to claim 8, wherein the distance element is configured to be fixed in position in advance by at least one of a nut and a spring and includes a bevel arranged on a side facing the support member.

14. A region of joining of a guide part and a follower part to a support member, comprising:
means for aligning the guide part with the support member positionally accurately;
a guide opening of the guide part positioned, in an assembled state of the support member and the guide part to overlap a position of an attachment region on the support member within tolerances to be compensated for;
a follower opening in the follower part arranged to coincide with the guide opening in accordance with the follower part being brought into a desired alignment with the guide part;
means conformed to an outer contour of the follower opening for penetrating the follower opening and the guide opening; and
means for fastening and fixing the follower part and the guide part in position in the attachment region with respect to the support member.
